(19) United States
(12) Patent Application Publication
(10) Pub. No.: US 2013/0035817 A1
(43) Pub. Date: Feb. 7, 2013

(54) LAND VEHICLE DRIVEN BY AN ELECTRIC OR HYDRAULIC MOTOR

(71) Applicants: Dany Taner Bahar, Hethel (GB); Colin Peachey, Hethel (GB)

(72) Inventors: Dany Taner Bahar, Hethel (GB); Colin Peachey, Hethel (GB)

(73) Assignee: LOTUS CARS LIMITED, Hethel, Norwich (GB)

(21) Appl. No.: 13/577,421

(22) PCT Filed: Feb. 21, 2011
(86) PCT No.: PCT/GB2011/000236

§ 371 Date: Aug. 6, 2012

(30) Foreign Application Priority Data
Feb. 19, 2010 (GB) 1002913.0

(51) Int. Cl. B60L 15/20; B60K 8/00; G05B 11/01; B60L 11/18

(52) U.S. Cl. 701/22; 701/70; 701/49

(57) ABSTRACT

With reference to the accompanying FIGURE, the present invention provides a land vehicle comprising: an electric or hydraulic motor for driving at least one driven wheel; a battery supplying electrical power or a source of hydraulic power; an electronic controller which controls operation of the electric or hydraulic motor; and a driver operated throttle control. The electronic controller receives a plurality of input signals including an input signal indicative of operation of the driver operated throttle control and implements a plurality of different operating regimes corresponding to a plurality of different simulated gear ratios. The controller selects an operating regime based on the plurality of input signals received thereby. The controller can operate the electric motor as a generator or the hydraulic motor as a pump to implement regenerative braking of the vehicle. Each operating regime has a level of regenerative braking unique thereto. Additionally or alternatively, a short term energy store is provided separate from the source of fluid pressure or the battery and the controller on sensing that a change from one simulated gear ratio to a lower simulated gear ratio is accompanied by a throttle control position which indicates that vehicle acceleration is required increases torque and/or power output of the electric or hydraulic motor by releasing energy from the short term energy store.

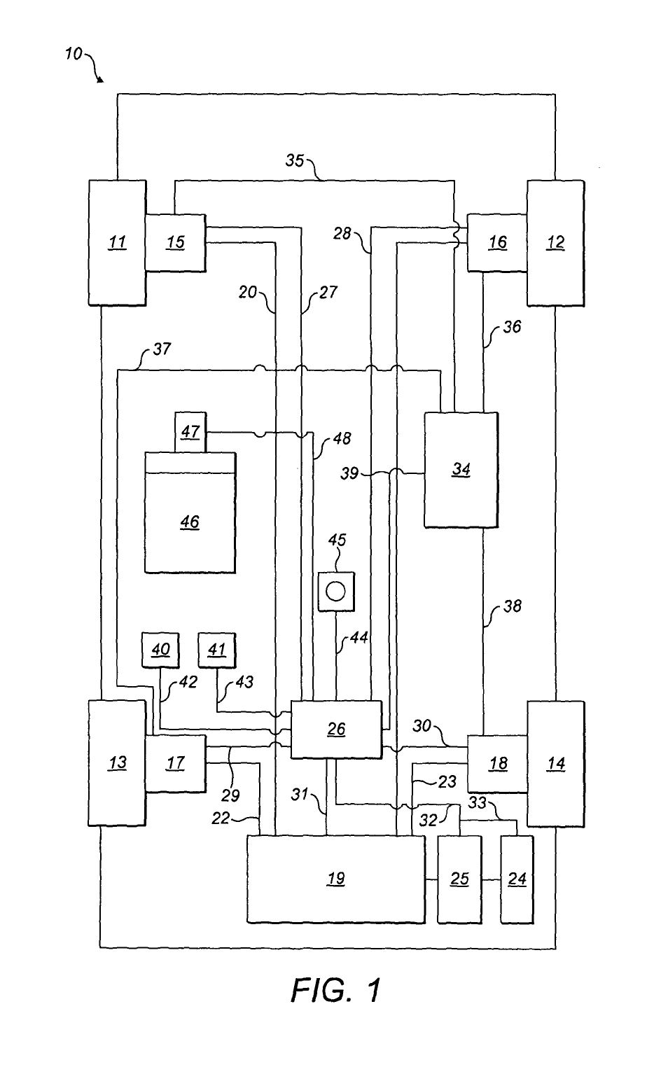

The present invention relates to a land vehicle and, in particular, to a land vehicle driven by an electric motor or a hydraulic motor.

Conventional land vehicles use internal combustion engines connected to driven wheels by a geared transmission. Gear ratio shifts are effected either manually by the driver using a stick shift and a clutch, automatically by a conventional automatic transmission or via a powered shift controlled by a driver using a semi-automatic transmission. In contrast a vehicle powered by an electric motor or a hydraulic motor typically has a transmission with only one or two gear ratios; this gives a very different driving experience, with the driver less involved in control of the land vehicle.

Conventional land vehicles with manual transmissions offer the driver the facility to use engine braking to slow down the land vehicle approaching a junction or to control speed of descent on hills. A driver will select a gear ratio lower than the highest in order to increase the speed of revolution of the engine, while keeping the throttle closed, in order to provide engine braking. The degree of engine braking depends on the gear selected by the driver. In top gear with the throttle closed the degree of engine braking is a minimum and in the lowest gear with the throttle closed the degree of engine braking is greatest. For instance if a car is driven on a motorway and the driver wishes to slow the car because of a slower vehicle ahead, the driver will keep the car in the highest gear and slow the vehicle only gently. On the other hand, as the car is slowed to a standstill, e.g. on approach to a roundabout, then the driver with manually select successively lower gears to benefit from successively increasing levels of engine braking. Furthermore, in descending a hill a driver will typically select a low gear to provide engine braking to keep the vehicle speed in check. Electrically and hydraulically powered land vehicles have in the past been configured to provide regenerative braking, i.e. converting kinetic energy of the vehicle into electrical power or hydraulic pressure to be stored for subsequent use, which provides an equivalent to engine braking. However, typically only one level of regenerative braking is provided. This is typically set a single level. This level might be too high for some situations, e.g. the case of gentle slowing at motorway speeds mentioned above, and too low for other situations, e.g. slowing to a dead stop approaching a roundabout. In some Lexus™ cars it is known to provide the driver with a switch to select between two levels of regeneration, but this is for use e.g. before first pulling away when driving the vehicle, not to permit continuous change of the levels of regenerative braking during driving of the vehicle.

In a first aspect the present invention provides a land vehicle as claimed in claim 1 or claim 17 and a method of operating a land vehicle as claimed in claim 12 or claim 28.

Conventional land vehicles with internal combustion engines offer a driver the ability to shift down to a lower gear to obtain greater torque and power output from an engine to accelerate past another vehicle. This facility has not been available in land vehicles powered by electric or hydraulic motors, where there is typically a fixed transmission ratio between the motors and the wheels. For instance, an electric motor will have a set torque curve solely dependent on speed of revolution.

In a second aspect the present invention provides a land vehicle as claimed in claim 14 and in claim 30.

Thus the driver when selecting a lower simulated gear can experience a surge of acceleration even though the transmission ratio between the motor and the driven wheels remains unchanged, thus replicating the experience of driving a known traditional car having an internal combustion engine and a multi-speed transmission.

Preferred embodiments of the present invention will now be described with reference to the accompanying drawing, which is a schematic representation of a vehicle according to the present invention.

In the FIGURE there is seen a land vehicle 10 comprising four driven wheels 11, 12, 13, 14. Each wheel is driven by a respective electric hub motor 15, 16, 17, 18. The electric hub motors are connected to an electric battery pack 19, the main long term energy store of the vehicle, via lines 20, 21, 22, 23 and are powered by electric power supplied by the battery pack 19. A small internal combustion engine 24 is coupled to an electric generator 25 and can be operated to provide electric power to top up the battery pack 19. A short term energy store 34, e.g. a capacitor, is connected to the hub motors 15, 16, 17, 18 by lines 35, 36, 37, 38. The key features of the preferred short energy store will be that it stores a relatively small amount of energy compared to the main energy store of the vehicle, but it capable of being charged and discharged at a higher rate than the main energy store. The short term energy store could store e.g. 200 KJ of energy. The short term energy store could be connected to the main energy store, e.g. the battery pack, and will typically be controlled to be kept on average with a charge 30% of its maximum capacity, with charge above this relayed over time to recharge the main energy store. In this way the short term energy store is available to accept energy generated by regenerative braking for a majority of the operation of the vehicle.

An electronic controller 26 is connected by control lines 27, 28, 29, 30 to the hub motors 15, 16, 17, 18 and controls operation of the hub motors. The electronic controller 26 is also connected by a communication line 31 to the battery pack 19 so that the controller 26 can monitor the state of charge of the battery pack 19. The electronic controller 26 is connected by control lines 32 and 33 to the generator 25 and engine 24 to control operation thereof. The controller 26 is also connected by a communication line 39 to the short term energy storage device 34 to control operation thereof and to monitor the state of charge thereof and to control flow of energy between the short term energy store and the battery pack 19 (as described above) and the hub motors.

In the FIGURE there can be seen a driver operable throttle pedal 40 and brake pedal 41. These are connected by communication lines 42, 43 to the controller 26. The brake pedal 41 will also typically be connected to conventional hydraulically foundation brakes (not shown). A ‘simulated gear shift selector’ 45 (the operation of which will be described below) is also provided as a driver operated control and is connected by a communications line 44 to the controller.

The vehicle 10 can operate with regenerative braking, i.e. the motors 15-18 can switch to operate as generators to slow the vehicle by converting kinetic energy of the vehicle into electrical energy, which can be used to top up the battery pack 19. The vehicle 10 is also provided with the short term energy store 34 which can also be charged by the regenerative braking. The short term energy store 34 could be charged first until fully charged and then the remaining energy used to charge the battery pack 19 or the battery pack 19 and the temporary energy store 19 could be charged in parallel. The controller 26 will manage the charging of the short term energy store 34 and battery pack 19 to ensure that there is sufficient capacity to store the recovered energy, e.g. by maintaining in the short term energy store a charge that is on average 30% of the total capacity of the store. It is important that the braking effort is always delivered at a consistent level for each simulated gear ratio selected by the driver using the selector 45 and this is managed by the controller 26. The vehicle will typically be provided with five, six or seven simulated gear ratios. Associated with each selected simulated gear ratio is a chosen level of regenerative braking. Selection of the lowest simulated gear ratio will, for instance, select 100% maximum regenerative braking effort when regenerative braking is activated (see below). Then for a vehicle with 6 simulated gear ratios, selection of a second simulated gear ratio (simulated to be higher than the first simulated gear ratio) will select 80% of the maximum regenerative braking effort, selection of a third simulated gear ratio (simulated to be higher than the second simulated gear ratio) will select 60% of the maximum regenerative braking effort, selection of a fourth simulated gear ratio (simulated to be higher than the third simulated gear ratio) will select 40% of the maximum regenerative braking effort, selection of a fifth simulated gear ratio (simulated to be higher than the fourth simulated gear ratio) will select 20% of the maximum regenerative braking effort and selection of a sixth simulated gear ratio (simulated to be the highest gear ratio) will deactivate regenerative braking entirely so that 0% regenerative braking effort is applied. In this way the electric vehicle can be operated with varying degrees of simulated engine braking and a driver used to driving a car with an internal combustion engine and a multi-speed gearbox will be presented with a similar experience in the electric vehicle.

The vehicle could be provided with any number of simulated gear ratios, although 4, 5, 6 or 7 would be typical, and the % reduction in regenerative braking effort between the gears will depend on the number of gear ratios simulated. In the example given above there is linear reduction in the amount of regenerative braking effort, 20% on selection of a higher gear, but this need not be the case and there could be a greater % reduction between some simulated gear ratios, e.g. between first and second, than between others, e.g. fifth and sixth. Also, whilst the difference in simulated gear ratios has been discussed above in terms of a reduction as a higher gear ratio is selected, there will be a corresponding increase in regenerative braking effort as a lower simulated gear ratio is selected, e.g. the regenerative braking effort will increase from 60% to 80% in the example given above as the driver selects a simulated down change from the simulated third gear ratio to the simulated second gear ratio.

The system can also be configured to “dump” energy if needed in extreme cases and/or the controller can be arranged to interact with the hydraulic braking system (not shown) to apply foundation brakes when the temporary energy store 34 and battery pack 19 are both fully charged (e.g. after a long descent).

In the FIGURE there is also seen a seat 46 for a driver. An actuator 47, e.g. an electronic actuator, is coupled to the seat 46 and is controlled by the controller 26 via a control line 48.

The driven wheels 11 to 14 in the vehicle shown are driven directly by hub motors 15-18 and there is no multi-ratio transmission included in the drive train. However, the electric vehicle of the present invention provides for simulation of gear shifts by providing the manually operable simulated gear shift selector 45 by which the driver can select a simulated gear shift (the selector does not actually select a change of different gear ratios, but instead selects a simulation of a shift of gear ratios) and by the controller 26 running algorithms which react to operation of the manually operable simulated gear shift selector 45 and in response to the other signals received thereby by one or more of:
1. reducing momentarily the torque output of the electric motors 11-14 to replicate clutch operation in a conventional land vehicle—the vehicle occupant will experience a change in the forces on them;
2. controlling the actuator 47 to induce a small jolt on the seat 46;
3. changing the torque characteristics of the electronic motors 15-18—it is typical for the maximum torque and power outputs of the electric motors to be significantly in excess of what is needed for normal vehicle use, hence the controller will operate a first control regime and restrict the power and torque outputs of the motors 15-18 in normal use and then, in response to input received from the accelerator pedal 40 and the gear ratio selector 45, operate a second control regime with higher power and torque outputs from the motors, thereby simulating a shift to a lower gear and providing extra acceleration, e.g. for an overtaking manoeuvre;
4. The controller 26 can release energy from the short term energy store 34 to supplement the electrical power from the battery pack to provide for increased acceleration. In a conventional car the changing down of a gear ratio increases the speed of revolution of the engine and makes available more power for acceleration. In an electric vehicle there will be no actual change of gear ratio. Therefore there is a technical problem of how to provide the driver of an electric vehicle with a similar experience. This is achieved by the current invention by the controller releasing stored energy from the short term energy store when the controller recognises that the driver has selected a lower simulated gear ratio with the throttle pedal depressed to demand acceleration of the vehicle.
5. in response to a combination of inputs from the throttle pedal 40 and gear ratio selector 45 (e.g. a downshift with no throttle pedal depression) implementing regenerative braking to simulate “engine braking” in a normal car—this allows driver control of regenerative braking and is efficient as the driver will anticipate a requirement for slowing, e.g. in approaching a junction or in controlling speed during a hill descent. As mentioned above, a different degree of regenerative braking will be provided for each selected simulated gear ratio. The regenerative braking will be applied when the throttle pedal position corresponds to that which would fully close the throttle in a conventional vehicle with an internal combustion engine. In each simulated gear ratio it is possible that a first degree of regenerative braking could be applied when with zero throttle pedal depression while a second higher degree of generation is implemented when the brake pedal 40 is also depressed.

By the above the controller 26 can implement a control strategy which provides to a driver of the vehicle 10 a driving experience which replicates that of an existing vehicle with a gearshift transmission.

It addition to the above, the controller could be programmed to have not only two operating regimes as described above, but three or more operating regimes each corresponding to a particular selected simulated gear ratio, selected by the driver using the simulated gear shift selector, with the controller in each operating regime controlling the electric motors to have a torque and/or power output unique to that regime in addition to having a level of regenerative braking unique to each selected simulated gear ratio. Within each operating regime two operating modes could be provided, a first in which the torque/power output of the motors is limited to a first level and a second in which the torque/power output of the motors is unlimited or is limited to a second level higher than the first level.

As an alternative to the above the gear ratio selector 45 could be replaced by paddles on the steering column.

As an alternative to the above, the controller could be programmed to mimic the gear changes and “kick down” provided by a standard automatic gearbox, using the input from the throttle pedal 40 and inputs indicative of the speed and torque outputs of the electric motors 11-14. Again the gear shifts will be simulated by momentary torque output reductions and/or by the actuator 47 jolting the chair 46. There will still be a different level of regenerative braking associated with each simulated gear ratio. The ‘kick down’ feeling provided by a conventional automatic gearbox by the selection of a lower gear ratio when the throttle pedal is quickly depressed to a large extent by a driver will be replicated by the controller releasing stored energy from the short term energy store. The controller can be configured to replicate a manual gearbox, a fully automatic gearbox or a semi-automatic gearbox. In replicating a semi automatic gearbox the controller will provide automatic changes of simulated gear ratio, but with manual intervention via a manually operable gear selector possible. The controller when functioning to replicate an automatic or semi-automatic gearbox will on acceleration simulate gear upshifts and will permit an automatic reduction of the regeneration levels as the vehicle accelerates so as the vehicle travels faster the regeneration is set to a lower level and is increased again when the driver requires regeneration by the action of downshifting. This feature provides an automatic reset of the regeneration levels and thereby a change in the levels of simulated engine braking. Similarly as the vehicle is slowed down the automatic gearbox simulation will put the vehicle into a lower simulated gear bringing the regenerative braking levels up. This feature automatically prevents the regeneration being left in an inappropriate setting for the driving speed, but allows the driver to manually select (either through ‘kick down’ in simulation of a fully automatic gearbox or manually through operation of a manually operable gear selector) the level of regeneration up or down from the nominal settings to give enhanced drivability. In simulation of a fully automatic transmission the level of regenerative braking will typically be changed mainly as a function of mainly vehicle speed i.e. as simulated gear ratio selected changes with speed. Whilst this provides less immediate driver control than in simulation of a semi-automatic function gearbox, this will still be an enhancement over purely fixed regenerative braking levels.

The controller by allowing a driver to select a desired simulated gear ratio and hence a desired level of regenerative braking allows the driver to select a level of regenerative braking which will assist in controlling vehicle speed during a hill descent. Furthermore, when driving on roads with mid to high speed corners and bends the driver of a conventional vehicle with an internal combustion engine often keeps the vehicle in a mid gear to enable by a degree of throttle pedal lift some engine braking to provide a greater level of control on corner entry. The present invention by allowing a driver to select a desired degree of regenerative braking will replicate for an electric vehicle this feature of an internal combustion engine car and hence enhance track or race driving.

Whilst above an electrically powered vehicle has been described, the present invention could also be applied to a vehicle which has hydraulic motors: the electric hub motors 15-18 would be replaced by hydraulic hub motors; the battery pack 19 by a store of pressurised fluid; the generator 25 by a pump (the store of pressurised fluid and the pump together provide a source of pressurised fluid for the vehicle); and the capacitor 34 by a flywheel or secondary store of hydraulic pressure.

The vehicle can be provided with visual indicator, e.g. a gauge or counter, equivalent to a revolutions per minute indicator typically provided for an internal combustion engine. The output of the visual indicator will be controlled by electronic controller having regard to both the speed of revolution of the electric motor or the hydraulic pump and also the simulated gear ratio which is selected. A different scalar of motor/pump speed of revolution will be used by the electronic controller for each simulated gear ratio. Vehicle speed could be used as an alternative to motor/pump speed in calculating the output of the visual indicator, if desired.

1. A land vehicle comprising:
at least one electric motor for driving at least one driven wheel;
a battery supplying electrical power to the electric motor;
an electronic controller which controls operation of the electric motor; and
a driver operated throttle control; wherein
the electronic controller receives a plurality of input signals including an input signal indicative of operation of the driver operated throttle control; and
the electronic controller implements a plurality of different operating regimes corresponding to a plurality of different simulated gear ratios and the electronic controller selects an operating regime based on the plurality of input signals received thereby; wherein
the electronic controller can operate the electric motor as a generator to implement regenerative braking of the vehicle with the motor functioning as a generator to generate electrical power from kinetic energy of the vehicle while applying a braking force on the vehicle and thereby simulating engine braking; and
each operating regime has a level of regenerative braking unique thereto, with an operating regime corresponding to a lowest simulated gear ratio having the highest level of regenerative braking and with an operating regime corresponding to a highest simulated gear ratio having the lowest level of regenerative braking and with other operating regimes corresponding to simulated gear ratios other than the highest and lowest having levels of regenerative braking in between the highest and lowest levels.

2. A land vehicle as claim 1 wherein the controller controls the electric motor to implement regenerative braking on selection of lower simulated gear ratio while the throttle control indicates a decrease in speed is required.

3. A land vehicle as claimed in claim 1, wherein:
the controller in each operating regime operates the electric motor with power and/or torque output
characteristics unique to the operating regime.

4. A land vehicle as claimed in any of claim 3, wherein:
the controller for each operating regime has a first mode of operation in which torque and/or power output of the electric motor is limited by the controller and a second mode of operation in which the electric motor is operated with an increased power and/or torque output limit or in which the electric motor is operated without the controller imposing a limit on power and/or torque output of the electric motor.

5. A land vehicle as claimed in claimed 4 wherein the controller for each operating regime selects the second mode of operation when the driver operated throttle control indicates that acceleration of the vehicle in required following a change from one simulated gear ratio to a lower simulated gear ratio.

6. A land vehicle as claimed in claim 1 wherein the electronic controller controls operation of the electric motor using a control strategy in which a shift between simulated gear ratios is accompanied by a temporary reduction in torque output of the electric motor.

7. A land vehicle as claimed in claim 1, comprising additionally:
a driver seat; and
an actuator connected to the driver seat; wherein the electronic controller controls the actuator and the actuator is controlled to move the driver seat during a change between simulated gear ratios.

8. A land vehicle as claimed in claim 1 comprising additionally:
a short term energy store separate from the battery and controlled by the controller; wherein
the controller on sensing selection of a lower
simulated gear ratio whilst a throttle control position indicates that vehicle acceleration is required increases torque and/or power output of the electric motor by
releasing energy from the short term energy store.

9. A land vehicle as claimed in claim 8 wherein the short term energy store receives and stores energy generated by the electric motor when operating as a generator during regenerative braking.

10. A land vehicle as a claimed in claim 9 wherein the short term energy store is a store of electrical energy and is connected to the battery to relay thereto and/or receive therefrom electrical energy and the electronic controller controls exchange of electrical energy between the short term energy store and the battery with the aim of maintaining the short term energy store at a desired partly charged level with excess energy above the desired partly charged level relayed to the battery.

11. A land vehicle as claimed in claim 1 comprising a driver operable gear selector which enables the driver to select a simulated gear ratio, the gear selector generating a gear selection signal which is sent to and processed by the electronic controller.

12. A method of operating a land vehicle which has at least one electric motor driving at least one driven wheel, the method comprising using an electronic controller to control operation of the electric motor in response to a plurality of input signals including a signal indicative of operation of a driver operated throttle control wherein:
the electronic controller implements a plurality of different operating regimes corresponding to a plurality of different simulated gear ratios and the electronic controller selects an operating regime based on the plurality of input signals received thereby;
the electronic controller can operate the electric motor as a generator to implement regenerative braking of the vehicle with the motor functioning as a generator to generate electrical power from kinetic energy of the vehicle while applying a braking force on the vehicle and thereby simulating engine braking; and
each operating regime implemented by the electronic controller has a level of regenerative braking unique thereto, with an operating regime corresponding to a lowest simulated gear ratio having the highest level of regenerative braking and with an operating regime corresponding to a highest simulated gear ratio having the lowest level of regenerative braking and with other operating regimes corresponding to simulated gear ratios other than the highest and lowest having levels of regenerative braking in between the highest and lowest levels.

13. A method as claimed in claim 12 wherein when the controller detects that a change to a lower simulated gear ratio is selected while no speed increase is requested by—operation, of the throttle control then the controller controls the electric motor to implement regenerative braking.

14. A land vehicle comprising:
at least one electric motor for driving at least one driven wheel;
a battery supplying electrical power to the electric motor;
an electronic controller which controls operation of the electric motor;
a driver operated throttle control; and
a short term energy store separate from the battery and controlled by the controller which can be charged and discharged more rapidly that the battery;
wherein:
the electronic controller receives a plurality of input signals including an input signal indicative of operation of the driver operated throttle control and implements a plurality of different operating regimes corresponding to a plurality of different simulated gear ratios and the electronic controller selects an operating regime based on the plurality of input signals received thereby; and
the controller on sensing that a change from one simulated gear ratio to a lower simulated gear ratio is accompanied by a throttle control position which indicates that vehicle acceleration is required increases torque and/or power output of the electric motor by releasing energy from the short term energy store.

15. A land vehicle as claimed in claim 14 wherein the short term energy store receives and stores energy generated by the electric motor when operating as a generator during regenerative braking.

16. A land vehicle as a claimed in claim 15 wherein the short term energy store is a store of electrical energy and is connected to the battery to relay to and/or receive therefrom electrical energy and the electronic controller controls exchange of electrical energy between the short term energy store and the battery with the aim of maintaining the short term energy store at a desired partly charged level, with excess energy above the desired partly charged level relayed to the battery.

17. A land vehicle as claimed in claim 14 comprising a driver operable gear selector which enables the driver to select a simulated gear ratio, the gear selector generating a gear selection signal which is sent to and processed by the electronic controller.

18. A land vehicle comprising:
at least one hydraulic motor for driving at least one driven wheel;
a source of fluid pressure supplying fluid power to the hydraulic motor;
an electronic controller which controls operation of the hydraulic motor; and
a driver operated throttle control; wherein
the electronic controller implements a plurality of different operating regimes corresponding to a plurality of different simulated gear ratios and the electronic controller selects an operating regime based on the plurality of input signals received thereby; wherein
the electronic controller can operate the hydraulic motor as a pump to implement regenerative braking of the vehicle with the motor functioning as a pump to generate hydraulic power from kinetic energy of the vehicle while applying a braking force on the vehicle and thereby simulating engine braking; and
each operating regime has a level of regenerative braking unique thereto, with an operating regime corresponding to a lowest simulated gear ratio having the highest level of regenerative braking and with an operating regime corresponding to a highest simulated gear ratio having the lowest level of regenerative braking and with other operating regimes corresponding to simulated gear ratios other than the highest and lowest ratios having levels of regenerative braking in between the highest and lowest levels.

19. A land vehicle as claim 18 wherein the controller controls the hydraulic motor to implement regenerative braking on a shift to a lower simulated gear ratio while operation of the throttle control indicates a decrease in speed is required.

20. A land vehicle as claimed in claim 18, wherein:
the controller in each operating regime operates the hydraulic motor with power and/or torque output characteristics unique to the operating regime.

21. A land vehicle as claimed in claim 20, wherein:
the controller for each operating regime has a first mode of operation in which torque and/or power output of the hydraulic motor is limited by the controller and a second mode of operation in which the hydraulic motor is operated with an increased power and/or torque output limit or in which the electric motor is operated without the controller imposing a limit on power and/or torque output of the electric motor.

22. A land vehicle as claimed in claimed 21 wherein the controller for each operating regime selects the second mode of operation where the driver operated throttle control indicates that acceleration of the vehicle in required following a change from one simulated gear ratio to a lower simulated gear ratio.

23. A land vehicle as claimed in claim 18 wherein the electronic controller controls operation of the hydraulic motor using a control strategy in which a shift between simulated gear ratios is accompanied by a temporary reduction in torque output of the hydraulic motor.

24. A land vehicle as claimed in claim 18, comprising additionally:
a driver seat; and
an actuator connected to the driver seat; wherein the electronic controller controls the actuator and the actuator is controlled to move the driver seat during a change between simulated gear ratios.

25. A land vehicle as claimed in claim 18 comprising additionally:
a short term energy store separate from the source of fluid pressure and controlled by the controller; wherein
the controller on sensing the selection of a lower simulated gear ratio accompanied by a throttle control position which indicates that vehicle acceleration is required increases torque and/or power output of the hydraulic motor by releasing energy from the short term energy store.

26. A land vehicle as claimed in claim 25 wherein the short term energy store receives and stores hydraulic fluid pressurised by the hydraulic motor when operating as a pump during regenerative braking.

27. A land vehicle as claimed in claim 18 comprising a driver operable gear selector which enables the driver to select a simulated gear ratio, the gear selector generating a gear selection signal which is sent to and processed by the electronic controller.

28. A method of operating a land vehicle which has at least one hydraulic motor driving at least one driven wheel, the method comprising using an electronic controller to control operation of the hydraulic motor in response to a plurality of input signals including a signal indicative of operation of a driver operated throttle control wherein:
the electronic controller implements a plurality of different operating regimes corresponding to a plurality of different simulated gear ratios and the electronic controller selects an operating regime based on the plurality of input signals received thereby;
the electronic controller can operate the hydraulic motor as a pump to implement regenerative braking of the vehicle with the motor functioning as a pump to pressurise hydraulic fluid using kinetic energy of the vehicle while applying a braking force on the vehicle and thereby simulating engine braking; and
each operating regime implemented by the electronic controller has a level of regenerative braking unique thereto, with an operating regime corresponding to a lowest simulated gear ratio having the highest level of regenerative braking and with an operating regime corresponding to a highest simulated gear ratio having the lowest level of regenerative braking and with other operating regimes corresponding to simulated gear ratios other than the highest and lowest ratios having levels of regenerative braking in between the highest and lowest levels.

29. A method as claimed in claim 28 wherein when the controller detects that a change to a lower simulated gear ratio is selected while no speed increase is requested by operation of the throttle control then the controller controls the electric motor to implement regenerative braking.

30. A land vehicle comprising:
at least one hydraulic motor for driving at least one driven wheel;
a source of fluid pressure supplying electrical power to the hydraulic motor;
an electronic controller which controls operation of the hydraulic motor;
a driver operated throttle control; and
a short term energy store separate from the source of fluid pressure and controlled by the controller;
wherein:
the electronic controller receives a plurality of input signals including an input signal indicative of operation of the driver operated throttle control and implements a plurality of different operating regimes corresponding to a plurality of different simulated gear ratios and the electronic controller selects an operating regime based on the plurality of input signals received thereby; and
the controller on sensing that a change from one simulated gear ratio to a lower simulated gear ratio is accompanied by a throttle control position which indicates that vehicle acceleration is required increases torque and/or power output of the hydraulic motor by releasing energy from the short term energy store.

31. A land vehicle as claimed in claim 30 wherein the short term energy store receives and stores energy generated by the hydraulic motor when operating as a pump during regenerative braking.

32. A land vehicle as claimed in claim 30 comprising a driver operable gear selector which enables the driver to select a simulated gear ratio, the gear selector generating a gear selection signal which is sent to and processed by the electronic controller.
